(19) United States
(12) Patent Application Publication
(10) Pub. No.: US 2026/0326226 A1
(43) Pub. Date: Oct. 22, 2026

(54) WELDED JOINT

(71) Applicant: NIPPON STEEL CORPORATION, Tokyo (JP)

(72) Inventors: Takuya MITSUNOBU, Tokyo (JP); Takafumi YOKOYAMA, Tokyo (JP); Hiroshi TAKEBAYASHI, Tokyo (JP)

(73) Assignee: NIPPON STEEL CORPORATION, Tokyo (JP)

(21) Appl. No.: 19/109,019

(22) PCT Filed: Sep. 6, 2023
(86) PCT No.: PCT/JP2023/032519

§ 371 Date: Mar. 5, 2025

(30) Foreign Application Priority Data
Sep. 6, 2022 (JP) 2022-141569

(51) Int. Cl. B23K 9/007; C22C 18/04; C22C 38/00; C22C 38/02; C22C 38/04; C22C 38/06; C22C 38/08; C22C 38/12; C22C 38/14; C22C 38/16; C22C 38/28; C22C 38/32; C22C 38/38; C23C 2/02; C23C 2/06; C23C 2/20

(52) U.S. Cl. CPC B23K 9/007; C22C 18/04; C22C 38/001; C22C 38/002; C22C 38/005; C22C 38/02; C22C 38/04; C22C 38/06; C22C 38/08; C22C 38/12; C22C 38/14; C22C 38/16; C22C 38/28; C22C 38/32; C22C 38/38; C23C 2/0224; C23C 2/024; C23C 2/06; C23C 2/20

(57) ABSTRACT

The present invention has as its technical problem to provide a welded joint suppressing LME cracking at the time of production. In the welded joint of the present invention, a plated steel sheet forming the welded joint has a predetermined chemical composition, at a non-heat affected zone of the welded joint, a depth with a C concentration measured by GDS of 0.05% or less in a depth direction of the base steel sheet starting from an interface of the plating layer and the base steel sheet of the plated steel sheet is 10 μm or more, a roughness of the interface of the plating layer and the base steel sheet of the plated steel sheet at the non-heat affected zone is an Ra of 3.0 μm or less, and at a position of 500 μm to the outside from an end part of the pressure contact zone, a thickness of a layer with an area ratio of a ferrite phase of 90% or more in a depth direction of the base steel sheet starting from an interface of the plating layer and the base steel sheet of the plated steel sheet is 15 μm or more.

### FIELD

The present invention relates to a welded joint. More specifically, the present invention relates to a welded joint suppressing LME cracking at the time of production.

### BACKGROUND

In recent years, the steel sheet used in automobiles, household electric appliances, building materials, and other various fields has been made increasingly higher in strength. For example, in the automotive field, welded joints obtained by spot welding high strength steel sheet have been increasingly used for the purpose of lightening the weight of car bodies so as to improve fuel efficiency.

In welding steel sheet which has been galvanized, in particular high strength steel sheet, for example, as described in PTL 1, sometimes the drop in weldability due to liquid metal embrittlement (LME) cracking becomes a problem. LME cracking is believed to occur because at the time of welding, the surface layer part of steel sheet transforms to austenite, the molten zinc invading the grain boundaries causes the steel sheet to become brittle, and further tensile stress acts on the steel sheet at the time of welding.

Further, as disclosed in NPL 1, relating to LME cracking, it is known that the grain boundaries of the ferrite phase are lower in LME sensitivity than austenite grain boundaries.

Note that, PTL 2 discloses, as steel sheet suppressed in LME cracking and improved in weldability, steel sheet at the surface layer part of which Si oxide particles with a particle size of 20 nm or more are present in a number density of 3000 to 6000/mm² and in a suitable particle size distribution.

### CITATIONS LIST

### Patent Literature

[PTL 1] WO2019/116531
[PTL 2] WO2020/218575

### NONPATENT LITERATURE

[NPL 1] “Influence of the starting microstructure of an advanced high strength steel on the characteristics of Zn-assisted liquid metal embrittlement”, D. Bhattacharya et. al., Materials Science and Engineering: A, Vol. 804, 2021

### SUMMARY

### Technical Problem

To prevent LME cracking at the time of production of welded joints, it is effective to keep the Zn etc. contained in the plating layer from penetrating steel sheet transformed to austenite. There is room for improvement on this point.

The present invention has as its technical problem, in consideration of such a situation, to provide a welded joint suppressing LME cracking at the time of production.

### Solution to Problem

The inventors engaged in in-depth studies for solving the above technical problem. As a result, they discovered that by including Si and Al in large amounts in steel sheet for spot welding, rendering the steel sheet a suitable surface state, and performing high dew point annealing, the surroundings of the welded part are decarburized, the ferrite (α) phase is stabilized, the steel sheet surface layer is covered by a ferrite phase with a low dissolved amount of C, and the ferrite phase is maintained in a stable state even at the time of production of the welded joint whereby it becomes possible to suppress LME.

The present invention was made by engaging in further studies based on the above findings and has as its gist the following:
(1) A welded joint comprising a plurality of overlaid steel sheets, a spot welded part having a nugget joining the plurality of steel sheets and a pressure contact zone and heat affected zone formed in the surroundings of the nugget, and a separation zone formed around the pressure contact zone, wherein at least one of the steel sheets among the plurality of steel sheets is a plated steel sheet provided with a base steel sheet and a plating layer, the plating layer being formed on at least a surface corresponding to an overlaid surface of the plurality of steel sheets and containing Zn; a tensile strength of the plated steel sheet is 780 MPa or more; the chemical composition of the base steel sheet comprises by mass %, C: 0.05 to 0.40%, Si: 0.7 to 3.0%, Mn: 0.1 to 5.0%, sol. Al: 0.7 to 2.0%, P: 0.0300% or less, S: 0.0300% or less, N: 0.0100% or less, B: 0 to 0.010%, Ti: 0 to 0.150%, Nb: 0 to 0.150%, V: 0 to 0.150%, Cr: 0 to 2.00%, Ni: 0 to 2.00%, Cu: 0 to 2.00%, Mo: 0 to 1.00%, W: 0 to 1.00%, Ca: 0 to 0.100%, Mg: 0 to 0.100%, Zr: 0 to 0.100%, Hf: 0 to 0.100%, REM: 0 to 0.100% and a balance of Fe and impurities, a total value of contents of Si and sol. Al is 1.8% or more; at a non-heat affected zone of the welded joint, a depth with a C concentration measured by GDS of 0.05% or less in a depth direction of the base steel sheet starting from an interface of the plating layer and the base steel sheet of the plated steel sheet is 10 μm or more; a roughness of the interface of the plating layer and the base steel sheet of the plated steel sheet is an Ra of 3.0 μm or less, and at a position of 500 μm to the outside from an end part of the pressure contact zone, a thickness of a layer with an area ratio of a ferrite phase of 90% or more in a depth direction of the base steel sheet starting from an interface of the plating layer and the base steel sheet of the plated steel sheet is 15 μm or more.
(2) The welded joint according to (1), wherein at the non-heat affected zone of the welded joint, the depth with a C concentration measured by GDS of 0.05% or less in a depth direction of the base steel sheet starting from an interface of the plating layer and the base steel sheet of the plated steel sheet is 15 μm or more.
(3) The welded joint according to (1), wherein at a position of 500 μm to the outside from an end part of the pressure contact zone, the thickness of the layer with an area ratio of a ferrite phase of 90% or more in the depth direction from the base steel sheet starting from an interface of the plating layer and the base steel sheet of the plated steel sheet is 30 μm or more.
(4) The welded joint according to (1), wherein at the non-heat affected zone of the welded joint, the depth with a C concentration measured by GDS of 0.05% or less in a depth direction of the base steel sheet starting from an interface of the plating layer and the base steel sheet of the plated steel sheet is 15 μm or more and at a position of 500 μm to the outside from an end part of the pressure contact zone, the thickness of the layer with an area ratio of a ferrite phase of 90% or more in the depth direction from the base steel sheet starting from an interface of the plating layer and the base steel sheet of the plated steel sheet is 30 μm or more.
(5) The welded joint of any one of (1) to (4) wherein at the non-heat affected zone, a roughness of the interface of the plating layer and the base steel sheet of the plated steel sheet is an Ra of 2.0 μm or less,

### Advantageous Effects of Invention

According to the present invention, it is possible to obtain a welded joint suppressing LME cracking at the time of production.

### BRIEF DESCRIPTION OF DRAWINGS

FIG. 1 is a view showing an outline of one example of a welded joint of the present invention.

FIG. 2 is a view showing a layer-shaped ferrite (α) phase formed in the vicinity of a welded part of a welded joint of the present invention. ha

FIG. 3 is a view for explaining evaluation of LME resistance in examples.

### DESCRIPTION OF EMBODIMENT

Below, the present invention will be explained. The present invention is not limited to the following embodiment. First, an outline of improvement of the LME resistance at the time of production in the welded joint of the present invention will be explained.

LME cracking occurs due to a surface layer part of steel sheet being heated at the time of spot welding, the steel sheet structure of the surface layer part transforming to austenite, and the molten plating penetrating the inside of the steel sheet structure along the grain boundaries of the austenite causing the crystal grain boundaries to become brittle. It is believed that LME cracking occurs since tensile stress is applied to the steel sheet at the time of welding. The welded joint of the present invention improves the LME resistance at the time of production of the welded joint by the structure formed at the surface layer of the steel sheet. Note that, in the Description, the “surface layer of the steel sheet” means the range from the surface of the steel sheet down to a depth of 100 μm.

If the C element is included in the steel sheet surface layer, LME cracking easily occurs, so keeping the C concentration of the steel sheet surface layer low is effective for preventing LME cracking. Usually, if heating steel sheet like in annealing, external oxidation occurs and oxide (scale) is formed at the steel sheet surface, so decarburization does not easily proceed. For this reason, the C concentration at the steel sheet surface layer does not easily fall. On the other hand, in the welded joint of the present invention, at the non-heat affected zone, the depth with a C concentration measured by GDS of 0.05% or less in a depth direction of the base steel sheet starting from an interface of the plating layer and the base steel sheet of the plated steel sheet forming the welded joint is 10 μm or more. This means at the surface layer of the plated steel sheet forming the welded joint, the concentration of C, an element by which LME is easily caused, is low and that state is maintained even after production of the welded joint.

In the present invention, at the time of production of the plated steel sheet forming the welded joint, strong strain is imparted to the surface layer and the steel sheet is annealed at a high dew point without increasing the surface roughness of the steel sheet. Due to this, oxygen diffuses to the inside of the steel sheet, internal oxides are formed, and formation of external oxides can be suppressed. Due to this, it is believed that the C concentration of the surface layer of the base steel sheet can be lowered.

Further, in the welded joint of the present invention, at a position 500 μm to the outside from an end part of the pressure contact zone, the thickness of the layer with an area ratio of the ferrite phase of 90% or more in a depth direction of the base material starting from the interface of the plating layer and base steel sheet of the plated steel sheet is 15 μm or more. That is, even in the vicinity of a heat affected zone, the ferrite phase remains stable. The “heat affected zone” here means the nonmelted part of the steel sheet changed in structure, metallurgical properties, mechanical properties, etc. by weld heat. The heat affected zone can be confirmed by observation of the cross-section in the sheet thickness direction under an SEM. Note that, the “non-heat affected zone” is a part other than the heat affected zone. Further, it is believed possible to stabilize the ferrite by the effect of composite addition of Si and sol. Al to the steel sheet.

That is, the welded joint of the present invention enables improvement of the LME resistance at the time of production of the welded joint by forming on the surface layer of the plated steel sheet a layer with a low C concentration and further a high area ratio of ferrite even if being affected by the heat due to welding by the combined effect of the high contents of Si and sol. Al of the plated steel sheet forming the welded joint, imparting strain to the surface layer before annealing, and control of the dew point at the time of annealing.

Below, the present invention will be explained in detail.

### <<Welded Joint>>

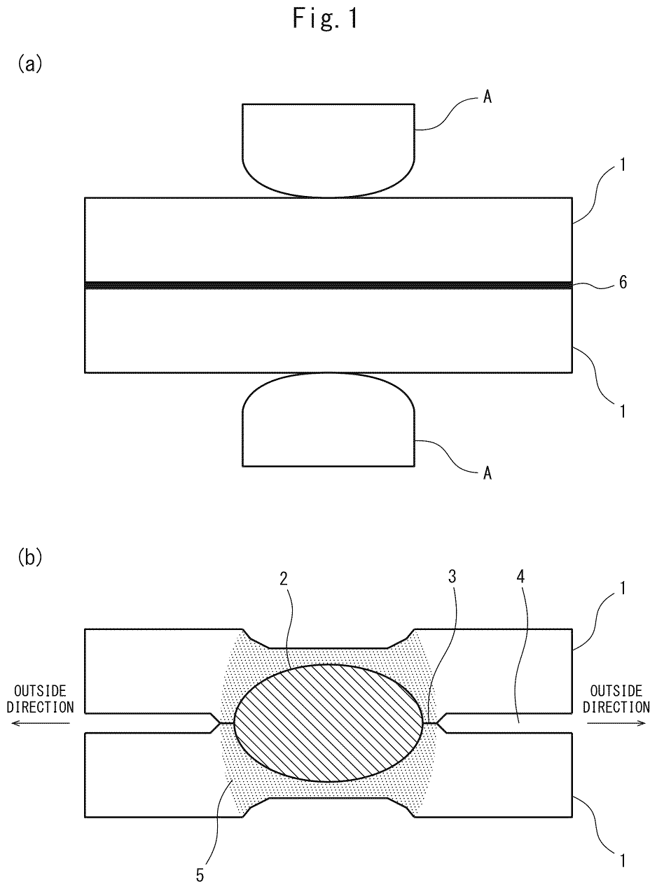

First, referring to FIG. 1, a welded joint of the present invention will be explained. As shown in FIG. 1(a), it is produced by spot welding a plurality of (in FIG. 1, two) steel sheets 1 using weld electrodes A. At the surfaces where the plurality of steel sheets 1 contact, overlaid surfaces 6 are formed.

FIG. 1(b) shows a welded joint comprised of two steel sheets welded by spot welding. The welded joint of the present invention is comprised of a plurality of overlaid steel sheets 1 and a nugget 2 joining the plurality of steel sheets. The nugget 2 is a part where the steel constituents and plating layer constituents have melted and resolidified due to spot welding. Around the nugget 2, a pressure contact zone 3 where the two steel sheets 1 have been pressure welded is formed. Around the pressure contact zone 3, a separation zone 4 is present. The separation zone 4 is a part where no welding or pressure weld has occurred due to spot welding and a part where the two steel sheets 1 are not directly contacting each other. The “end of the pressure contact zone” means the position of the pressure contact zone 3 closest to the separation zone 4. The “outside” from the pressure contact zone refers to the direction from the end of the pressure contact zone 3 toward the open part of the separation zone 4. Further, around the nugget 2, a heat affected zone 5 changed in structure, metallurgical properties, mechanical properties, etc. by weld heat is formed.

The plurality of steel sheets forming the welded joint of the present invention can include both of a plated steel sheet provided with a base steel sheet and a plating layer and a nonplated steel sheet which is not plated. At least one of the plurality of steel sheets is a plated steel sheet. The plating layer is formed at least at a surface corresponding to an overlaid surface 6 of a steel sheet. Further, the tensile strength of the plated steel sheet is 780 MPa or more.

LME cracking, as explained above, occurs when there is molten zinc plating present on the surface of high strength (tensile strength 780 MPa or more) steel sheet at the time of welding. Therefore, if considering a welded joint formed from two steel sheets, if one of the two steel sheets is a high strength plated steel sheet, LME cracking may occur. The welded joint of the present invention includes high strength plated steel sheet for the steel sheets forming the welded joint and can suppress LME cracking at the time of production of a welded joint.

### <Chemical Composition of Steel Sheet>

First, the chemical composition of a base steel sheet of a plated steel sheet forming the welded joint will be explained. Below, the “%” relating to the chemical composition will mean “mass %”. Further, in the numerical ranges in the chemical composition, numerical ranges expressed using “to” will mean ranges including the numerical values described before and after “to” as lower limit values and upper limit values.

### (C: 0.05 to 0.40%)

C (carbon) is an element securing the strength of steel. To obtain the 780 MPa or more tensile strength covered by the present invention, considering the balance with weldability and, further, to keep the C concentration of the surface layer of the steel sheet from becoming too high, the content of C is made 0.05 to 0.40%. If the content of C is too large, even with the later explained high dew point annealing, the C concentration of the base steel sheet surface layer will no longer become low. The content of C may be 0.07% or more, 0.10% or more, or 0.12% or more. The content of C may also be 0.35% or less, 0.30% or less, or 0.25% or less.

(Si: 0.7 to 3.0%, sol. Al: 0.7 to 2.0%, Si+sol. Al≥1.8%)

Si (silicon) is an element promoting ferrite stabilization and decarburization by composite addition with Al (aluminum). To obtain the effect of LME suppression, Si: 0.7 to 3.0% and sol. Al: 0.7 to 2.0% are included and further the total value of the contents of Si and sol. Al is made 1.8% or more. “sol. Al” means the acid soluble Al not becoming an oxide such as Al₂O₃ and able to dissolve in an acid. It is found as the Al measured after excluding the undissolved residue on filter paper formed in the process of analysis of Al. The content of Si may be 0.8% or more, 0.9% or more, or 1.0% or more. The content of Si may be 2.8% or less, 2.5% or less, or 2.0% or less. The content of sol. Al may be 0.8% or more, 0.9% or more, or 1.0% or more. The content of sol. Al may also be 1.8% or less, 1.6% or less, or 1.5% or less. The total value of the contents of Si and sol. Al may be 1.9% or more, 2.0% or more, or 2.2% or more.

### (Mn: 0.1 to 5.0%)

Mn (manganese) is an element effective for improving the strength of steel by obtaining hard structures. Considering the balance of the strength of steel and drop in formability by Mn segregation, the content of Mn is made 0.1 to 5.0%. The content of Mn may be 0.5% or more, 1.0% or more, or 1.5% or more. The content of Mn may also be 4.5% or less, 4.0% or less, or 3.5% or less.

### (P: 0.0300% or Less)

P (phosphorus) is an impurity generally contained in steel. With a content of P of more than 0.0300%, the weldability is liable to fall. Therefore, the content of P is made 0.0300% or less. The content of P may be 0.0200% or less, 0.0100% or less, or 0.0050% or less. It is preferable that P not be included, so the lower limit of the content of P is 0%. From the viewpoint of dephosphorization costs, the content of P may be more than 0%, 0.0001% or more, or 0.0005% or more.

### (S: 0.0300% or Less)

S (sulfur) is an impurity generally contained in steel. With a content of S of more than 0.0300%, the weldability falls. Further, the amount of precipitation of MnS increases and the bendability and other formability is liable to fall. Therefore, the content of S is made 0.0300% or less. The content of S may also be 0.0100% or less, 0.0050% or less, 0.0030% or less, 0.0020% or less, or 0.0010% or less. It is preferable that S not be included, so the lower limit of the content of S is 0%. From the viewpoint of the desulfurization costs, the content of S may be more than 0%, 0.0001% or more, or 0.0005% or more.

### (N: 0.0100% or Less)

N (nitrogen) is an impurity generally contained in steel. With a content of N of more than 0.0100%, the weldability is liable to fall. Therefore, the content of N is made 0.0100% or less. The content of N may also be 0.0080% or less, 0.0050% or less, 0.0030% or less, 0.0020% or less, or 0.0010% or less. It is preferable that N not be included, so the lower limit of the content of N is 0%. From the viewpoint of the production costs, the content of N may be more than 0%, 0.0001% or more, 0.0002% or more, 0.0003% or more, or 0.0005% or more.

### (B: 0 to 0.010%)

B (boron) is an element raising the hardenability and contributing to improvement of the strength and, further, segregating at the grain boundaries to strengthen the grain boundaries and improve the toughness, so may be included in accordance with need. It is not an essential element, so the lower limit of the content of B is 0%. This effect is also obtained by inclusion in a trace amount, but the content of B when included is preferably 0.0001% or more. The content of B may also be 0.0002% or more, 0.0003% or more, 0.0005% or more, 0.0007% or more, or 0.0010% or more. On the other hand, from the viewpoint of securing sufficient toughness, the content of B is made 0.010% or less. The content of B may also be 0.0080% or less, 0.0060% or less, 0.0050% or less, 0.0040% or less, or 0.0030% or less.

### (Ti: 0 to 0.150%)

Ti (titanium) is an element precipitating as TiC during cooling of the steel and contributing to improvement of the strength, so may be included in accordance with need. It is not an essential element, so the lower limit of the content of Ti is 0%. This effect is also obtained by inclusion in a trace amount, but the content of Ti when included is preferably 0.0001% or more. The content of Ti may be 0.0002% or more, 0.0003% or more, 0.0005% or more, 0.0007% or more, or 0.0010% or more. On the other hand, if excessively included, coarse TiN is formed and the toughness is liable to be impaired, so the content of Ti is made 0.150% or less. The content of Ti may also be 0.1000% or less, 0.0500% or less, 0.0300% or less, 0.0200% or less, 0.0100% or less, 0.0050% or less, or 0.0030% or less.

### (Nb: 0 to 0.150%)

Nb (niobium) is an element contributing to improvement of strength through improvement of the hardenability, so may be included in accordance with need. It is not an essential element, so the lower limit of the content of Nb is 0%. This effect is also obtained by inclusion in a trace amount, but the content of Nb when included is preferably 0.001% or more. The content of Nb may be 0.002% or more, 0.003% or more, 0.005% or more, or 0.008% or more. On the other hand, from the viewpoint of securing sufficient toughness, the content of Nb is made 0.150% or less. The content of Nb may also be 0.100% or less, 0.060% or less, 0.050% or less, 0.040% or less, or 0.030% or less.

### (V: 0 to 0.150%)

V (vanadium) is an element contributing to improvement of strength through improvement of hardenability, so may be included in accordance with need. It is not an essential element, so the lower limit of the content of V is 0%. This effect is also obtained by inclusion in a trace amount, but the content of V when included is preferably 0.001% or more. The content of V may be 0.002% or more, 0.003% or more, or 0.005% or more. On the other hand, from the viewpoint of securing sufficient toughness, the content of V is made 0.150% or less. The content of V may also be 0.100% or less, 0.060% or less, 0.050% or less, 0.040% or less, 0.030% or less, or 0.020% or less.

### (Cr: 0 to 2.00%)

Cr (chromium) is an element effective for raising the hardenability of steel to raise the strength of steel, so may be included in accordance with need. It is not an essential element, so the lower limit of the content of Cr is 0%. This effect is also obtained by inclusion in a trace amount, but the content of Cr when included is preferably 0.001% or more. The content of Cr may be 0.01% or more, 0.02% or more, 0.03% or more, 0.05% or more, or 0.08% or more. On the other hand, if excessively included, Cr carbides are formed in large amounts and conversely the hardenability is liable to be impaired, so the content of Cr is made 2.00% or less. The content of Cr may be 1.80% or less, 1.50% or less, 1.20% or less, 1.00% or less, 0.70% or less, 0.50% or less, or 0.30% or less.

### (Ni: 0 to 2.00%)

Ni (nickel) is an element effective for raising the hardenability of steel to raise the strength of steel, so may be included in accordance with need. It is not an essential element, so the lower limit of the content of Ni is 0%. This effect is also obtained by inclusion in a trace amount, but the content of Ni when included is preferably 0.001% or more. The content of Ni may be 0.01% or more or 0.02% or more. On the other hand, excessive addition of Ni causes the cost to rise, so the content of Ni is made 2.00% or less. The content of Ni may be 1.80% or less, 1.50% or less, 1.20% or less, 1.00% or less, 0.80% or less, 0.50% or less, 0.30% or less, 0.20% or less, 0.10% or less, or 0.05% or less.

### (Cu: 0 to 2.00%)

Cu (copper) is an element effective for raising the hardenability of steel to raise the strength of steel, so may be included in accordance with need. It is not an essential element, so the lower limit of the content of Cu is 0%. This effect is also obtained by inclusion in a trace amount, but the content of Cu when included is preferably 0.0001% or more. The content of Cu may be 0.0002% or more, 0.0003% or more, or 0.0005% or more. On the other hand, from the viewpoint of suppressing a drop in toughness or cracking of the slab after casting, the content of Cu is made 2.00% or less. The content of Cu may also be 1.8000% or less, 1.5000% or less, 1.2000% or less, 1.0000% or less, 0.5000% or less, 0.1000% or less, 0.0500% or less, 0.0100% or less, 0.0050% or less, 0.0030% or less, or 0.0020% or less.

### (Mo: 0 to 1.00%)

Mo (molybdenum) is an element effective for raising the hardenability of steel to raise the strength of steel, so may be included in accordance with need. It is not an essential element, so the lower limit of the content of Mo is 0%. This effect is also obtained by inclusion in a trace amount, but the content of Mo when included is preferably 0.001% or more. The content of Mo may be 0.01% or more, 0.02% or more, 0.03% or more, 0.05% or more, or 0.08% or more. On the other hand, from the viewpoint of suppressing a drop in toughness, the content of Mo is made 1.00% or less. The content of Mo may also be 0.90% or less, 0.70% or less, 0.50% or less, or 0.30% or less.

### (W: 0 to 1.00%)

W (tungsten) is an element effective for raising the hardenability of steel to raise the strength of steel, so may be included in accordance with need. It is not an essential element, so the lower limit of the content of W is 0%. This effect is also obtained by inclusion in a trace amount, but the content of W when included is preferably 0.001% or more. The content of W may be 0.002% or more, 0.005% or more, or 0.01% or more. On the other hand, from the viewpoint of suppressing a drop in toughness, the content of W is made 1.00% or less. The content of W may also be 0.90% or less, 0.70% or less, 0.50% or less, 0.30% or less, 0.10% or less, 0.05% or less, or 0.03% or less.

### (Ca: 0 to 0.100%)

Ca (calcium) is an element contributing to control of inclusions, in particular fine dispersion of inclusions, and having the action of raising the toughness, so may be included in accordance with need. It is not an essential element, so the lower limit of the content of Ca is 0%. This effect is also obtained by inclusion in a trace amount, but the content of Ca when included is preferably 0.0001% or more. The content of Ca may be 0.0002% or more. On the other hand, if excessively included, deterioration of the surface properties sometimes appears, so the content of Ca is made 0.100% or less. The content of Ca may also be 0.0800% or less, 0.0500% or less, 0.0100% or less, 0.0050% or less, 0.0030% or less, 0.0020% or less, 0.0010% or less, 0.0008% or less, or 0.0005% or less.

### (Mg: 0 to 0.100%)

Mg (magnesium) is an element contributing to control of inclusions, in particular fine dispersion of inclusions, and having the action of raising the toughness, so may be included in accordance with need. It is not an essential element, so the lower limit of the content of Mg is 0%. This effect is also obtained by inclusion in a trace amount, but the content of Mg when included is preferably 0.0001% or more. The content of Mg may be 0.0002% or more, 0.0003% or more, 0.0005% or more, or 0.0008% or more. On the other hand, if excessively included, deterioration of the surface properties sometimes appears, so the content of Mg is made 0.100% or less. The content of Mg may be 0.090% or less, 0.080% or less, 0.050% or less, 0.010% or less, 0.005% or less, or 0.003% or less.

### (Zr: 0 to 0.100%)

Zr (zirconium) is an element contributing to control of inclusions, in particular fine dispersion of inclusions, and having the action of raising the toughness, so may be included in accordance with need. It is not an essential element, so the lower limit of the content of Zr is 0%. This effect is also obtained by inclusion in a trace amount, but the content of Zr when included is preferably 0.001% or more. The content of Zr may be 0.002% or more, 0.003% or more, 0.005% or more, or 0.010% or more. On the other hand, if excessively included, deterioration of the surface properties sometimes appears, so the content of Zr is made 0.100% or less. The content of Zr may be 0.080% or less, 0.050% or less, 0.040% or less, or 0.030% or less.

### (Hf: 0 to 0.100%)

Hf (hafnium) is an element contributing to control of inclusions, in particular fine dispersion of inclusions, and having the action of raising the toughness, so may be included in accordance with need. It is not an essential element, so the lower limit of the content of Hf is 0%. This effect is also obtained by inclusion in a trace amount, but the content of Hf when included is preferably 0.0001% or more. The content of Hf may be 0.0002% or more, 0.0003% or more, 0.0005% or more, or 0.0008% or more. On the other hand, if excessively included, deterioration of the surface properties sometimes appears, so the content of Hf is made 0.100% or less. The content of Hf may also be 0.050% or less, 0.030% or less, 0.010% or less, 0.005% or less, or 0.003% or less.

### (REM: 0 to 0.100%)

An REM (rare earth element) is an element contributing to control of inclusions, in particular fine dispersion of inclusions, and having the action of raising the toughness, so may be included in accordance with need. It is not an essential element, so the lower limit of the content of an REM is 0%. This effect is also obtained by inclusion in a trace amount, but the content of an REM when included is preferably 0.0001% or more. The content of an REM may be 0.0003% or more or 0.0005% or more. On the other hand, if excessively included, deterioration of the surface properties sometimes appears, so the content of an REM is made 0.100% or less. The content of an REM may be 0.0500% or less, 0.0300% or less, 0.0100% or less, 0.0050% or less, 0.0030% or less, or 0.0020% or less. Note that, “REM” is an abbreviation for “rare earth metal” and means elements belonging to the lanthanoids. An REM is usually added as a mischmetal.

In a base steel sheet of a plated steel sheet forming the welded joint according to the present invention, the balance besides the above chemical composition is comprised of Fe and impurities. Here, “impurities” mean constituents which enter due to various factors in the production process, first and foremost the raw materials such as ore and scrap, when industrially producing steel sheet and which do not have a detrimental effect on the LME resistance at the time of production of the welded joint according to the present invention.

The chemical composition of the base steel sheet may be analyzed using any element analysis method known to a person skilled in the art, for example, inductively coupled plasma-mass spectrometry (ICP-MS). However, C and S may be measured using the combustion-infrared absorption method, and N may be measured using the inert gas melting-thermal conductivity method. These analyses may be performed by samples taken from the base steel sheet by the method based on JIS G0417: 1999.

At least one of the plurality of steel sheets forming the welded joint of the present invention is a plated steel sheet provided with a base steel sheet and a plating layer. The plating layer contains Zn. Further, the plating layer is formed at least on the surface corresponding to an overlaid surface of the plurality of steel sheets. The plating layer is not particularly limited so long as containing Zn. As one example, Zn-0.2% Al, Zn-0.5% Al, Zn-1.5% Al-1.5% Mg, Zn-20% Al-7% Mg, and Zn-30% Al-10% Mg may be mentioned. The plating layer may also be formed at other than the surface corresponding to an overlaid surface of the plurality of steel sheets.

The chemical composition of the plating layer can be determined by dissolving the plating layer in an acid solution to which an inhibitor for suppressing corrosion of the base steel sheet has been added and measuring the obtained solution by ICP (inductively coupled plasma) emission spectrometry.

The thickness of the plating layer may for example be 3 to 50 μm. Further, the amount of deposition of the plating layer is not particularly limited, but for example may be 10 to 170 g/m² per surface. In the present invention, the amount of deposition of the plating layer is determined by dissolving the plating layer in an acid solution to which an inhibitor suppressing corrosion of the base steel sheet is added and finding the change in weight before and after pickling and peeling of the plating layer. The thickness of the plating layer may be 5 μm or more, 10 μm or more, 15 μm or more, or 20 μm or more. The thickness of the plating layer may be 40 μm or less or 30 μm or less. The amount of deposition of the plating layer may also be, per surface, 20 g/m² or more, 30 g/m² or more, 40 g/m² or more, or 50 g/m² or more. The amount of deposition of the plating layer may also be, per surface, 150 g/m² or less, 130 g/m² or less, 120 g/m² or less, or 100 g/m² or less.

The sheet thickness of a plated steel sheet forming the welded joint of the present invention is not particularly limited. For example, it may be made 0.6 to 3.2 mm. The sheet thickness may also be 0.8 mm or more or 1.0 mm or more. The sheet thickness may also be 3.0 mm or less, 2.6 mm or less, 2.4 mm or less, 2.2 mm or less, 2.0 mm or less, or 1.8 mm or less.

Next, the structure of a plated steel sheet forming the welded joint will be explained.

### [C Concentration of Non-Heat Affected Zone]

In the welded joint of the present invention, in the non-heat affected zone, the depth with a C concentration measured by GDS of 0.05% or less in the depth direction of the base steel sheet starting from the interface of the plating layer and base steel sheet of the plated steel sheet is 10 μm or more. The heat affected zone is a part changing in material properties due to heat in the process of spot welding and can be confirmed by SEM observation. The non-heat affected zone is a part other than the heat affected zone. A position 5 mm or more from the outer end of a spot welded part may be deemed a non-heat affected zone, so the measurement is performed at a position 5 mm or more away from the outer end of the spot welded part.

The LME sensitivity falls if the C concentration becomes lower, so by lowering the C concentration of the non-heat affected zone, the LME suppression effect at the time of production of the welded joint is improved. Further, C is an austenite stabilizing element, so if this is small, the ferrite phase with a low LME sensitivity explained later stabilizes.

Such a structure can be obtained by making the chemical composition of the base steel sheet of the plated steel sheet, as explained above, constituents in which Si and Al are included in large amounts, performing the later explained heat treatment, and performing spot welding.

If the depth with a C concentration of 0.05% or less is 10 μm or more, the effect of suppression of LME at the time of production is obtained, so the upper limit of the depth is not particularly prescribed. For example, the depth may be 50 μm or less, 40 μm or less, or 30 μm or less. The depth with a C concentration of 0.05% or less is preferably 25 μm or more.

The GDS measurement is performed five times in the sheet thickness direction. The average value of the measurements is made the C concentration. The measurement conditions are as explained below: The starting point of the “depth” is the interface of the base steel sheet and the plating layer. The interface of the base steel sheet and plating layer is made the position where the concentration of Fe measured by GDS measurement becomes 93% of the concentration of Fe at the depth of 150 μm.
Apparatus: high frequency glow discharge optical emission spectrometry (made by LECO Japan, model “GDS850A”)
Ar gas pressure: 0.3 MPa
Anode diameter: 4 mmφ
RF output: 30 W
Measurement time: 200 to 1500 seconds

### [Interface Roughness at Non-Heat Affected Zone]

In the welded joint of the present invention, the roughness of the interface of the plating layer and base steel sheet of the plated steel sheet at the non-heat affected zone is an arithmetic average height Ra defined by JIS B0601:2013 of 3.0 μm or less. Here, the “interface of the plating layer and base steel sheet” means the actual interface of the plating layer and base steel sheet. If the roughness becomes larger, stress concentration causes cracking to easily occur. The roughness of the interface of the plating layer and base steel sheet may be an Ra of 2.5 μm or less or 2.0 μm or less. At the interface of the plating layer and base steel sheet, the surface roughness of the base steel sheet measured after removal of the plating may be deemed the roughness of the interface of the plating layer and base steel sheet. The plating is removed by dissolving the plating layer in an acid solution to which an inhibitor suppressing corrosion of steel sheet is added.

### [Ferrite Phase Outside of Pressure Weld Zone]

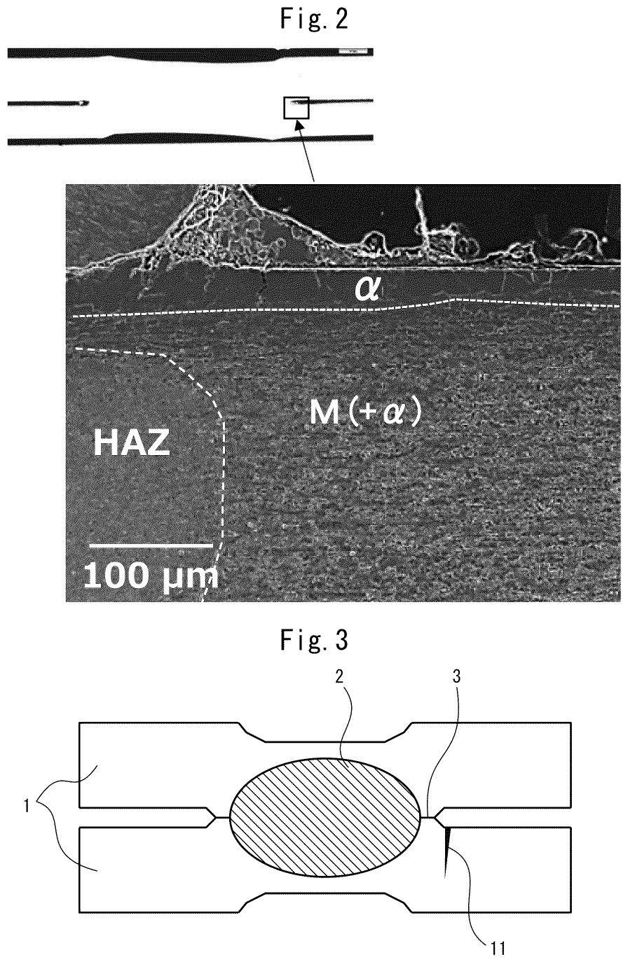

In the welded joint of the present invention, the thickness of the layer with an area ratio of the ferrite phase of 90% or more at a position of 500 μm in any direction outside from an end of the pressure contact zone in the depth direction of the base steel sheet starting from the interface of the plating layer and base steel sheet of the plated steel sheet is 15 μm or more. FIG. 2 shows one example of a structural photograph by SEM of the surroundings of a welded part of a welded joint of the present invention. FIG. 2 shows the pressure contact zone and separation zone of a welded joint. The black part at the top right is the separation zone. At the surface layer of the steel sheet at the bottom side, a layer with an area ratio of the ferrite (α) phase of 90% or more is formed. The inside of the steel sheet is martensite (M). Some ferrite (α) is also present. Further, near the pressure contact zone, a heat affected zone (HAZ) changed in structure by the weld heat is formed.

It is known that the grain boundaries of the ferrite phase are lower in LME sensitivity than the γ (austenite) grain boundaries (for example, NPL 1). Therefore, by making the surroundings of the welded part of the welded joint a structure with a stable ferrite phase even at the time of welding, it is possible to enhance the LME suppression effect at the time of production of a welded joint. Such a surface layer structure can be obtained by making the chemical composition of the base steel sheet, as explained above, a composition in which Si and Al are contained in large amounts, performing the heat treatment explained later, then spot welding.

If the thickness of the layer with an area ratio of the ferrite phase of 90% or more is 15 μm or more, the effect of improvement of the LME resistance is obtained, so the upper limit of the thickness is not particularly limited. The thickness may be, for example, 100 μm or less, 80 μm or less, or 60 μm or less. The thickness of the layer with an area ratio of the ferrite phase of 90% or more may be 20 μm or more or 30 μm or more.

The thickness of the layer with an area ratio of the ferrite phase of 90% or more is found by etching by Nital a cross-section obtained by cutting the welded joint vertically to the steel sheet surface and examining it by SEM so as to identify martensite, bainite, ferrite, etc. from the form of the structure. Here, the “area ratio of the ferrite phase” means the area ratio found by observation at the cross-section cut vertical to the steel sheet surface. Even if there is locally a location where the area ratio of a ferrite phase becomes less than 90% in the middle of the thickness direction when observing the cross-section cut parallel to the steel sheet surface, there is no problem so long as the area ratio of a ferrite phase of the cross-section cut vertical at the depth down to 15 μm is 90% or more. The more specific area ratio is as explained below:

The ferrite area ratio is found by cutting out a cross-section of the steel sheet in the sheet thickness direction crossing the rolling direction, polishing it to a mirror surface, then corroding it by a Nital solution to reveal the steel structure and using a field emission scanning electron microscope to capture a secondary electron image. Each observed position is made a position of 500 μm to the outside from an end of the pressure contact zone. Observed positions of five fields are determined at equal intervals at any positions in the rolling direction (direction vertical to paper surface at FIG. 1(b)) and examined. The ferrite area ratio is made the average value of the five fields. In the obtained structural photographs, the point counting method is used to calculate the percentages of the different structures. More specifically, an evenly spaced grid is drawn on the structural photograph. Next, it is judged which of tempered martensite, pearlite, ferrite, fresh martensite, or retained austenite or bainite the structures at the grid points correspond to. The numbers of grid points corresponding to the different structures can be found and divided by the total number of grid points to measure the percentages of the different structures. The greater the total number of grid points, the more accurately the volume ratio can be found. In the present invention, the grid spacings are made 2 μm×2 μm and the total number of grid points is made 1500 points.

The criteria for judgment of tempered martensite, pearlite, ferrite, fresh martensite, or retained austenite or bainite are as follows: A region having substructures (lath boundaries and block boundaries) in the grains and having carbides precipitating in several variants is judged as tempered martensite. Further, a region in which cementite precipitates in a lamellar form is judged as pearlite. A region in which the brightness is low and no substructures can be observed is judged as ferrite. A region in which the brightness is high and substructures are not brought out by etching is judged as fresh martensite or retained austenite. A region not corresponding to any of the above is judged as bainite. Simply put, if differentiating ferrite and other structures, the area ratio of the ferrite phase can be found.

### [Tensile Strength of Plated Steel Sheet]

The present invention suppresses the LME which occurs in high strength steel sheet, so the plated steel sheet forming the welded joint is high in strength. Specifically, it has a 780 MPa or more tensile strength. The upper limit of the tensile strength is not particularly prescribed, but from the viewpoint of securing toughness, for example, it may be 2000 MPa or less. The tensile strength may be measured by taking a JIS No. 5 tensile test piece having a direction orthogonal to the rolling direction as its longitudinal direction and subjecting it to JIS Z 2241:2011. The tensile strength may be 880 MPa or more, 980 MPa or more, 1080 MPa or more, or 1180 MPa or more. The tensile strength may also be 1900 MPa or less or 1800 MPa or less.

Note that when a test piece for tensile strength measurement cannot be obtained from the plated steel sheet forming a welded joint, alternatively it is possible to measure the hardness (Vickers hardness) of the plated steel sheet at the non-heat affected zone at a distance 5 mm or more away from the outer end of the spot welded part and estimate the value of the tensile strength from the following relationship (Relationship Between Static Strength Parameters, Fumihiko Hasegawa, Junichi Arai, Tsuneshichi Tanaka, “Materials”, Vol. 39, No. 442, P 859-863).

Hv=0.301×TS+5.701
(where, Hv is the Vickers hardness and TS is the tensile strength (unit: MPa).

That is, if the hardness is 240 Hv or so or more, the tensile strength may be deemed to be 780 MPa or more.

The hardness of the plated steel sheet is measured at a position of a non-heat affected zone of the plated steel sheet forming the welded joint at a position of ½ depth. The hardness is measured based on JIS Z 2244:2009. The measurement load is made 200 gf. The hardness of the plated steel sheet at the non-heat affected zone at a distance of 5 mm or more away from the outer end of the spot welded part may be 245 Hv or more, 250 Hv or more, 260 Hv or more, 270 Hv or more, 300 Hv or more, or 340 Hv or more.

Next, the method of production of the welded joint according to the present invention will be explained. First, the method of production of the base steel sheet of a plated steel sheet forming the welded joint will be explained.

### <Method of Production of Base Steel Sheet>

A base steel sheet of a plated steel sheet forming the welded joint according to the present invention can, for example, be obtained by a method of production provided with a casting step of casting molten steel adjusted in chemical composition to form a steel slab, a hot rolling step of hot rolling the steel slab to obtain hot rolled steel sheet, a coiling step of coiling the hot rolled steel sheet, a cold rolling step of cold rolling the coiled hot rolled steel sheet to obtain a cold rolled steel sheet, a pretreatment step of brush grinding the cold rolled steel sheet, and an annealing step of annealing the treated cold rolled steel sheet. Alternatively, it is also possible to not perform coiling after the hot rolling step but to perform pickling then cold rolling in that state.

### [Casting Step]

The conditions of the casting step are not particularly limited. For example, it is sufficient to cast the steel by melting it in a blast furnace or electric arc furnace etc., then performing various secondary refining processes, then performing the usual continuous casting, casting by the ingot method, etc. or other method.

### [Hot Rolling Step]

The steel slab obtained by the casting can be hot rolled to obtain hot rolled steel sheet. The hot rolling step is performed by hot rolling the cast steel slab directly or after reheating after cooling it once. If reheating, the heating temperature of the steel slab may be, for example, 1100 to 1250° C. In the hot rolling step, usually rough rolling and finish rolling are performed. The temperatures and reduction rates of the rolling processes may be suitably changed in accordance with the desired microstructure and sheet thickness. For example, the end temperature of the finish rolling may be 900 to 1050° C. and the reduction rate of the finish rolling may be 10 to 50%.

### [Coiling Step]

The hot rolled steel sheet can be coiled at a predetermined temperature. The coiling temperature may be suitably changed in accordance with the desired microstructure etc. For example, it may be 500 to 800° C. Predetermined heat treatment may be applied to the hot rolled steel sheet before coiling or after coiling. Alternatively, the steel sheet need not be coiled, but can be pickled then cold rolled as explained later after the hot rolling step.

### [Cold Rolling Step]

After the hot rolled steel sheet is pickled etc., the hot rolled steel sheet can be cold rolled to obtain cold rolled steel sheet. The reduction rate in the cold rolling may be suitably changed in accordance with the desired microstructure and sheet thickness. For example, it may be 20 to 80%. After the cold rolling step, for example, the steel sheet may be air cooled to cool it down to room temperature.

### [Pretreatment Step]

As explained above, at the welded joint, at the non-heat affected zone, to make the depth with a C concentration measured by GDS of 0.05% or less in the depth direction of the base steel sheet starting from the interface of the plating layer and base steel sheet of the plated steel sheet 10 μm or more and, at a position of 500 μm to the outside from an end of the pressure contact zone, to make the thickness of the layer with an area ratio of the ferrite phase of 90% or more starting from the interface of the plating layer and base steel sheet of the plated steel sheet 15 μm or more, it is necessary to perform predetermined pretreatment before annealing of the steel sheet and then perform annealing.

The pretreatment includes using a brush roll to grind the cold rolled steel sheet surface (brush rolling). As the brush roll which can be used, for example, M-33 made by Hotani Co., Ltd. may be mentioned. Due to this, strain can be introduced without making the roughness of the surface greater. At the time of grinding, the steel sheet surface may be coated with an NaOH 1.0 to 5.0% aqueous solution. The brush grinding reduction may be made 0.5 to 10.0 mm and the speed 100 to 1000 rpm. By controlling the coating solution conditions, brush grinding reduction, and speed in performing the brush grinding, decarburization is promoted in the annealing step explained below and a structure making the ferrite stable even around the welded part at the time of production of the welded joint can be efficiently formed at the surface layer of the steel sheet.

### [Annealing Step]

After the pretreatment step, the cold rolled steel sheet is annealed. The annealing is, for example, performed in a state applying 1 to 20 MPa tension. If applying tension at the time of annealing, it becomes possible more effectively introduce strain to the steel sheet and decarburization of the surface layer is promoted.

The holding temperature of the annealing step is made 750 to 900° C. The holding temperature may also be 770 to 870° C. By making it such a range, it is possible to promote decarburization, reduce the C concentration of the surface layer, and stabilize the ferrite phase. The rate of temperature rise up to the holding temperature is not particularly limited, but may be 1 to 10° C./s.

The holding time at the holding temperature of the annealing step is made 20 to 300 seconds. The holding time may be between 30 to 250 seconds. By making it such a range, it is possible to promote decarburization, reduce the C concentration of the surface layer, and stabilize the ferrite phase.

The atmosphere of the annealing step is made the dew point-30 to 20° C. The dew point may also be −10 to 5° C. The atmosphere, for example, may also be N₂₋₁ to 10 vol % H₂, N₂₋₂ to 4 vol % H₂. If the dew point is too high or too low, a phase containing Si, Mn, Al, and other oxides is formed at the outside of the steel sheet and sometimes mutual diffusion of the plating constituents and steel constituents is obstructed and the plateability becomes insufficient.

Due to the method of production provided with the above-mentioned steps, in the surface layer of the steel sheet, decarburization is promoted and steel sheet with a stabilized ferrite phase even at the time of production of the welded joint can be obtained.

### <Method of Production of Plated Steel Sheet>

The plated steel sheet forming the welded joint according to the present invention can be obtained by plating for forming a plating layer containing Zn on a base steel sheet produced in the above way.

The plating may be performed in accordance with a method known to persons skilled in the art. For example, the plating is performed by hot dip coating. The conditions of the plating may be suitably set considering the desired chemical composition, thickness, amount of deposition, etc. of the plating layer. For example, it may be performed by dipping in a 420 to 480° C. hot dip galvanization bath adjusted in chemical composition for 1 to 10 seconds, pulling out the sheet after dipping at 20 to 200 mm/s, and wiping by N₂ gas to control the amount of plating deposition. Alloying may be performed at for example 500 to 550° C. for 10 to 60 seconds.

### <Spot Welding Step>

A plurality of steel sheets including the above-mentioned plated steel sheet are overlaid and spot welded to obtain a welded joint. The conditions of the spot welding are not particularly limited. For example, weld electrodes of a dome radius type having tip diameters of 6 to 8 mm can be used for spot welding at a squeezing force of 1.5 to 6.0 kN, an energizing time of 0.1 to 1.0 second, and an energizing current of 4 to 15 kA.

The welded joint according to the present invention is suppressed in LME cracking at the time of production, so can be suitably used in automobiles, household electrical appliances, building materials, and other broad fields. In particular, they are preferably used in the automotive field.

### EXAMPLES

Below, examples will be used to explain the present invention in more detail. The present invention is not limited to these examples.

### Example 1

### (Fabrication of Plated Steel Sheet Sample)

Molten steel adjusted to the chemical composition described in No. 1 of Table 1 was smelted in a blast furnace and cast by continuous casting to obtain a steel slab. The obtained steel slab was heated to 1200° C. and hot rolled by an end temperature of finish rolling of 950° C. and a reduction rate of the finish rolling of 30% to obtain hot rolled steel sheet. The obtained hot rolled steel sheet was wound by a coiling temperature of 650° C., pickled, then cold rolled by a reduction rate of 50% to obtain cold rolled steel sheet. The thickness of the cold rolled steel sheet was made 1.6 mm.

Next, the cold rolled steel sheet was coated with an NaOH 2.0% aqueous solution and brush ground as pretreatment. The brush grinding was performed using an M-33 made by Hotani as the brush roll with a brush grinding reduction of 2.0 mm and speed of 600 rpm (Condition A of Table 2).

Before the annealing step, the surface roughness of the steel sheet was measured based on JIS B 0601:2013. That is, at the surface at the surface layer part side, 10 locations were randomly selected. The surface profile was measured by a contact type surface roughness meter at the respective locations. The arithmetic average roughness Ra obtained by arithmetically averaging the surface roughnesses at these locations was evaluated as follows:
Evaluation AA: 2.0 μm or less
Evaluation A: more than 2.0 μm and 3.0 μm or less
Evaluation B: more than 3.0 μm

After that, annealing was performed at a dew point of 0° C., a holding temperature of 800° C., and a holding time of 100 seconds in a furnace with an oxygen concentration of 20 ppm or less in an N₂₋₄% H₂ gas atmosphere. The temperature raising rate at the time of annealing was made 6.0° C./s up to 500° C. and 2.0° C./s from 500° C. to the holding temperature. The annealing was performed in a state applying 15 MPa tension.

After the annealing, the steel sheet was plated to obtain hot dip galvanized steel sheet. The plating was performed by dipping in a 460° C. hot dip galvanization bath (Zn-0.2% Al) for 3 seconds. After dipping, the steel sheet was pulled out at 100 mm/s and was controlled in plating deposition amount to 50 g/m² by N₂ wiping gas to obtain a plated steel sheet.

### Examples 2 to 28 and Comparative Examples 29 to 41

Except for making the chemical compositions those described in Table 1, making the conditions of the pretreatment step and annealing step those described in Table 2, and making the type of plating those described in Table 3, the same procedures were followed as in Example 1 to produce plated steel sheets. Note that, in No. 40, the pretreatment by brush grinding was omitted. Further, in No. 41, in the pretreatment, a brush roll made D-100 made by Hotani was used (Condition B of Table 2). D-100 is a brush roll with a grinding amount of 2 times or so that of M-33.

The composition of the type of plating and the bath temperature shown in Table 3 were as follows: F was made plating, then alloying at, 530° C. for 20 seconds to perform hot dip galvannealing.
A: Zn-0.2% Al (460° C.)
B: Zn-0.5% Al (440° C.)
C: Zn-1.5% Al-1.5% Mg (500° C.)
D: Zn-20% Al-7% Mg (530° C.)
E: Zn-30% Al-10% Mg (530° C.)
F: Zn-0.14% Al (450° C.)
hot dip galvannealing

TABLE 1

| | | Chemical composition (mass %), balance: Fe and impurities | | | | | | | | | | |
|---|---|---|---|---|---|---|---|---|---|---|---|---|
| No. | Class | C | Si | Mn | sol. Al | P | S | N | B | Ti | Others | Si + sol. Al |
| 1 | Ex. | 0.05 | 1.0 | 2.0 | 0.8 | 0.0001 | 0.0005 | 0.0002 | | | | 1.8 |
| 2 | Ex. | 0.10 | 0.9 | 2.0 | 0.9 | 0.0080 | 0.0003 | 0.0002 | 0.0005 | 0.0006 | | 1.8 |
| 3 | Ex. | 0.10 | 0.9 | 2.2 | 1.1 | 0.0080 | 0.0007 | 0.0004 | 0.0006 | 0.0002 | Hf: 0.001 | 2.0 |
| 4 | Ex. | 0.10 | 1.2 | 2.2 | 1.0 | 0.0070 | 0.0006 | 0.0008 | 0.0001 | 0.0001 | | 2.2 |
| 5 | Ex. | 0.10 | 1.0 | 2.2 | 0.8 | 0.0020 | 0.0009 | 0.0008 | 0.0002 | 0.0008 | Mg: 0.001 | 1.8 |
| 6 | Ex. | 0.20 | 1.0 | 2.0 | 1.0 | 0.0100 | 0.0007 | 0.0006 | 0.0003 | 0.0009 | | 2.0 |
| 7 | Ex. | 0.20 | 0.9 | 2.0 | 1.0 | 0.0020 | 0.0005 | 0.0003 | 0.0003 | 0.0002 | Zr: 0.015 | 1.9 |
| 8 | Ex. | 0.20 | 1.1 | 2.2 | 0.7 | 0.0008 | 0.0009 | 0.0008 | 0.0002 | 0.0002 | Cr: 0.1 | 1.8 |
| 9 | Ex. | 0.20 | 1.0 | 2.5 | 1.0 | 0.0017 | 0.0004 | 0.0008 | 0.0002 | 0.0004 | Ni: 0.02 | 2.0 |
| 10 | Ex. | 0.20 | 1.0 | 2.3 | 0.8 | 0.0011 | 0.0007 | 0.0003 | 0.0006 | 0.0003 | Cu: 0.0007 | 1.8 |
| 11 | Ex. | 0.20 | 1.0 | 2.3 | 1.0 | 0.0031 | 0.0006 | 0.0005 | 0.0003 | 0.0010 | Zr: 0.015 | 2.0 |
| 12 | Ex. | 0.20 | 1.0 | 2.5 | 1.0 | 0.0065 | 0.0003 | 0.0008 | 0.0009 | 0.0010 | | 2.0 |
| 13 | Ex. | 0.20 | 1.0 | 2.2 | 1.0 | 0.0092 | 0.0006 | 0.0005 | 0.0005 | 0.0010 | | 2.0 |
| 14 | Ex. | 0.20 | 1.0 | 2.3 | 1.0 | 0.0035 | 0.0005 | 0.0005 | 0.0003 | 0.0009 | | 2.0 |
| 15 | Ex. | 0.20 | 1.0 | 2.5 | 1.0 | 0.0022 | 0.0006 | 0.0009 | 0.0004 | 0.0006 | | 2.0 |
| 16 | Ex. | 0.25 | 1.0 | 2.2 | 1.0 | 0.0012 | 0.0009 | 0.0005 | 0.0004 | 0.0005 | Nb: 0.010 | 2.0 |
| 17 | Ex. | 0.25 | 1.0 | 2.2 | 1.0 | 0.0040 | 0.0002 | 0.0006 | 0.0007 | 0.0003 | V: 0.007 | 2.0 |
| 18 | Ex. | 0.30 | 1.0 | 2.5 | 1.0 | 0.0099 | 0.0010 | 0.0001 | 0.0009 | 0.0004 | | 2.0 |
| 19 | Ex. | 0.20 | 1.0 | 2.3 | 1.0 | 0.0031 | 0.0006 | 0.0002 | 0.0004 | 0.0008 | Zr: 0.015 | 2.0 |
| 20 | Ex. | 0.20 | 1.0 | 2.5 | 1.0 | 0.0031 | 0.0003 | 0.0002 | 0.0007 | 0.0007 | Zr: 0.015 | 2.0 |
| 21 | Ex. | 0.20 | 1.0 | 2.3 | 1.0 | 0.0031 | 0.0007 | 0.0006 | 0.0005 | 0.0009 | Zr: 0.015 | 2.0 |
| 22 | Ex. | 0.30 | 1.0 | 0.3 | 1.2 | 0.0110 | 0.0008 | 0.0003 | 0.0005 | 0.0003 | | 2.2 |
| 23 | Ex. | 0.35 | 1.0 | 5.0 | 1.0 | 0.0092 | 0.0002 | 0.0004 | 0.0004 | 0.0008 | Mo: 0.1 | 2.0 |
| 24 | Ex. | 0.35 | 1.0 | 2.2 | 0.9 | 0.0091 | 0.0003 | 0.0005 | 0.0003 | 0.0009 | REM: 0.0006 | 1.9 |
| 25 | Ex. | 0.40 | 1.0 | 2.2 | 1.0 | 0.0045 | 0.0008 | 0.0007 | 0.0004 | 0.0008 | | 2.0 |
| 26 | Ex. | 0.40 | 1.0 | 2.2 | 1.0 | 0.0035 | 0.0009 | 0.0003 | 0.0002 | 0.0009 | W: 0.02 | 2.0 |
| 27 | Ex. | 0.40 | 1.0 | 2.2 | 1.0 | 0.0082 | 0.0002 | 0.0006 | 0.0007 | 0.0002 | Ca: 0.0002 | 2.0 |
| 28 | Ex. | 0.40 | 1.0 | 2.2 | 1.0 | 0.0080 | 0.0003 | 0.0003 | 0.0003 | 0.0007 | | 2.0 |
| 29 | Comp. ex. | 0.42 | 1.0 | 2.0 | 1.0 | 0.0100 | 0.0003 | 0.0004 | 0.0002 | 0.0006 | | 2.0 |
| 30 | Comp. ex. | 0.20 | 0.6 | 2.0 | 1.0 | 0.0100 | 0.0002 | 0.0006 | 0.0008 | 0.0005 | | 1.6 |
| 31 | Comp. ex. | 0.20 | 3.1 | 2.0 | 1.0 | 0.0098 | 0.0004 | 0.0005 | 0.0005 | 0.0010 | | 4.1 |
| 32 | Comp. ex. | 0.20 | 1.2 | 2.0 | 0.6 | 0.0100 | 0.0002 | 0.0008 | 0.0002 | 0.0009 | | 1.8 |
| 33 | Comp. ex. | 0.20 | 1.0 | 2.0 | 0.6 | 0.0100 | 0.0002 | 0.0008 | 0.0002 | 0.0009 | | 1.6 |
| 34 | Comp. ex. | 0.20 | 1.0 | 2.0 | 2.2 | 0.0100 | 0.0007 | 0.0006 | 0.0003 | 0.0002 | | 3.2 |
| 35 | Comp. ex. | 0.20 | 0.7 | 2.0 | 0.7 | 0.0100 | 0.0005 | 0.0002 | 0.0009 | 0.0005 | | 1.4 |
| 36 | Comp. ex. | 0.20 | 1.0 | 2.0 | 1.0 | 0.0100 | 0.0003 | 0.0007 | 0.0003 | 0.0002 | | 2.0 |
| 37 | Comp. ex. | 0.20 | 1.0 | 2.0 | 1.0 | 0.0100 | 0.0003 | 0.0009 | 0.0001 | 0.0002 | | 2.0 |
| 38 | Comp. ex. | 0.20 | 1.0 | 2.0 | 1.0 | 0.0100 | 0.0002 | 0.0007 | 0.0002 | 0.0002 | | 2.0 |
| 39 | Comp. ex. | 0.08 | 1.0 | 2.0 | 1.0 | 0.0100 | 0.0002 | 0.0002 | 0.0009 | 0.0007 | | 2.0 |
| 40 | Comp. ex. | 0.20 | 1.0 | 2.0 | 1.0 | 0.0100 | 0.0004 | 0.0001 | 0.0008 | 0.0001 | | 2.0 |
| 41 | Comp. ex. | 0.20 | 1.0 | 2.0 | 1.0 | 0.0100 | 0.0009 | 0.0008 | 0.0003 | 0.0005 | | 2.0 |
| 42 | Comp. ex. | 0.20 | 1.0 | 2.0 | 1.0 | 0.0100 | 0.0003 | 0.0003 | 0.0007 | 0.0008 | | 2.0 |

* Underlines indicate outside scope of present invention

TABLE 2

| | | Pretreatment step | | Annealing step | | |
|---|---|---|---|---|---|---|
| | | | Surface roughness | Holding | Holding | Dew point |
| No. | Class | Condition | after pretreatment | temp.(°C) | time (s) | (°C) |
| 1 | Ex. | A | A | 800 | 100 | 0 |
| 2 | Ex. | A | A | 800 | 90 | 0 |
| 3 | Ex. | A | A | 800 | 220 | 0 |
| 4 | Ex. | A | AA | 820 | 100 | 0 |
| 5 | Ex. | A | AA | 840 | 100 | 0 |
| 6 | Ex. | A | AA | 860 | 80 | 0 |
| 7 | Ex. | A | AA | 860 | 100 | 0 |
| 8 | Ex. | A | AA | 860 | 100 | 0 |
| 9 | Ex. | A | AA | 860 | 100 | 0 |
| 10 | Ex. | A | AA | 860 | 100 | 0 |
| 11 | Ex. | A | AA | 860 | 20 | 0 |
| 12 | Ex. | A | AA | 860 | 100 | 0 |
| 13 | Ex. | A | AA | 900 | 20 | 0 |
| 14 | Ex. | A | AA | 750 | 50 | 0 |
| 15 | Ex. | A | AA | 780 | 200 | 0 |
| 16 | Ex. | A | AA | 860 | 100 | 0 |
| 17 | Ex. | A | AA | 860 | 40 | 0 |
| 18 | Ex. | A | AA | 860 | 100 | 0 |
| 19 | Ex. | A | AA | 860 | 20 | 0 |
| 20 | Ex. | A | AA | 860 | 20 | 0 |
| 21 | Ex. | A | AA | 860 | 20 | 0 |
| 22 | Ex. | A | AA | 860 | 300 | 0 |
| 23 | Ex. | A | AA | 860 | 200 | 0 |
| 24 | Ex. | A | A | 860 | 200 | 0 |
| 25 | Ex. | A | AA | 860 | 200 | 0 |
| 26 | Ex. | A | AA | 860 | 200 | −20 |
| 27 | Ex. | A | AA | 860 | 200 | 0 |
| 28 | Ex. | A | AA | 860 | 200 | 0 |
| 29 | Comp. ex. | A | A | 800 | 60 | 0 |
| 30 | Comp. ex. | A | A | 800 | 60 | 0 |
| 31 | Comp. ex. | A | A | 800 | 50 | 0 |
| 32 | Comp. ex. | A | A | 800 | 70 | 0 |
| 33 | Comp. ex. | A | A | 800 | 60 | 0 |
| 34 | Comp. ex. | A | A | 800 | 60 | 0 |
| 35 | Comp. ex. | A | A | 800 | 60 | 0 |
| 36 | Comp. ex. | A | A | 800 | 60 | −40 |
| 37 | Comp. ex. | A | A | 800 | 60 | 30 |
| 38 | Comp. ex. | A | A | 720 | 60 | 0 |
| 39 | Comp. ex. | A | A | 920 | 60 | 0 |
| 40 | Comp. ex. | A | A | 800 | 10 | 0 |
| 41 | Comp. ex. | None | A | 800 | 60 | 0 |
| 42 | Comp. ex. | B | B | 800 | 60 | 0 |

* Underlines indicate outside scope of preferred method of production

### (Evaluation of Tensile Strength)

From each plated steel sheet, a JIS No. 5 tensile test piece having a direction orthogonal to the rolling direction as a longitudinal direction was taken. A tensile test was performed based on JIS Z 2241:2011 to find the tensile strength. This was evaluated in the following way.
Evaluation AAA: 1180 MPa or more
Evaluation AA: 980 MPa or more and less than 1180 MPa
Evaluation A: 780 MPa or more and less than 980 MPa

### (Fabrication of Welded Joint)

Two of each of the plated steel sheets were overlaid and spot welded using dome radius type welding electrodes with an 8 mm tip diameter, an electrode angle of 2°, a squeezing force of 4.0 kN, an energizing time of 0.5 second, and an energizing current of 12 kA to produce a welded joint. The LME suppression effect (LME resistance) at the time of production was evaluated.

The LME resistance was evaluated as follows by the length of LME cracking formed right outside the pressure contact zone of the welded part. Referring to FIG. 3, the evaluation of the LME resistance will be explained. The LME resistance was evaluated by measuring the LME crack length formed at the part at the right outside of the pressure contact zone 3 formed by overlaying two steel sheets 1 and spot welding them and right outside the pressure contact zone near the part which was pressure welded. The length of the crack 11 right outside the pressure contact zone was used for evaluation as follows: In the present embodiment, if the evaluation is A or more, it was judged that the LME resistance was excellent. If the evaluation is “A” or more, it was judged that the LME resistance was excellent and the technical problem of the present invention was solved.
Evaluation AAA: 0 μm
Evaluation AA: more than 0 μm and less than 60 μm
Evaluation A: 60 μm or more and less than 120 μm
Evaluation B: 120 μm or more

### (Evaluation of Structure in Vicinity of Welded Part)

The welded joint was cut to obtain a sample. This was measured by GDS five times in the sheet thickness direction under the above-mentioned conditions at the position forming the non-heat affected zone starting from the interface of the plating layer and base steel sheet. The depth with a C concentration of 0.05% or more was found and shown in “C≤0.05% depth” of Table 3.

Further, at a position forming the non-heat affected zone, the plating was removed using a 10 mass % hydrochloric acid solution to which 0.06 mass % inhibitor (ibit made by Asahi Chemical Co., Ltd.) was added. The roughness of the surface of the exposed base steel sheet was measured by a method similar to that before the annealing and was shown in “base steel sheet/plating surface roughness” of Table 3.

Further, at a position of 500 μm to the outside from an end of the pressure contact zone, the thickness of the layer with an area ratio of the ferrite phase of 90% or more was measured by the above-mentioned method starting from the interface of the plating layer and base steel sheet and was shown in “a phase thickness” of Table 3.

The results of evaluation are shown in Table 3.

TABLE 3

| | | | Non-heat affected zone | | | | |
|---|---|---|---|---|---|---|---|
| | | | | Base steel | Right outside pressure | | |
| | | Tensile | C ≤ 0.05% | sheet/plating | contact zone | | Performance |
| | | strength | depth | interface | α phase | Plating | LME |
| No. | Class | (MPa) | (μm) | roughness (μm) | thickness (μm) | type | resistance |
| 1 | Ex. | A | 24 | 3.0 | 24 | A | AA |
| 2 | Ex. | AA | 25 | 2.2 | 25 | A | AA |
| 3 | Ex. | A | 34 | 2.5 | 61 | A | AA |
| 4 | Ex. | AA | 20 | 1.7 | 31 | A | AAA |
| 5 | Ex. | AA | 20 | 1.7 | 21 | F | A |
| 6 | Ex. | AA | 24 | 2.0 | 30 | A | AAA |
| 7 | Ex. | AA | 22 | 1.5 | 38 | A | AAA |
| 8 | Ex. | AA | 22 | 1.3 | 26 | A | AA |
| 9 | Ex. | AA | 20 | 1.0 | 41 | A | AAA |
| 10 | Ex. | AA | 20 | 1.8 | 43 | A | AAA |
| 11 | Ex. | AA | 10 | 1.5 | 15 | A | A |
| 12 | Ex. | AA | 24 | 1.2 | 46 | C | AA |
| 13 | Ex. | AA | 17 | 1.5 | 22 | A | A |
| 14 | Ex. | AA | 10 | 1.5 | 15 | A | A |
| 15 | Ex. | AA | 21 | 1.1 | 33 | A | AAA |
| 16 | Ex. | AAA | 21 | 1.5 | 36 | A | AAA |
| 17 | Ex. | AAA | 18 | 1.8 | 25 | A | A |
| 18 | Ex. | AAA | 20 | 1.7 | 40 | A | AAA |
| 19 | Ex. | AA | 11 | 1.2 | 22 | B | A |
| 20 | Ex. | AA | 10 | 1.3 | 20 | D | AAA |
| 21 | Ex. | AA | 11 | 1.2 | 21 | E | AAA |
| 22 | Ex. | AA | 40 | 1.9 | 80 | A | AAA |
| 23 | Ex. | AAA | 28 | 1.5 | 36 | A | AAA |
| 24 | Ex. | AAA | 28 | 2.2 | 34 | A | AAA |
| 25 | Ex. | AAA | 26 | 1.0 | 32 | A | AAA |
| 26 | Ex. | AAA | 24 | 1.7 | 31 | A | AAA |
| 27 | Ex. | AAA | 22 | 1.1 | 31 | A | AAA |
| 28 | Ex. | AAA | 20 | 1.2 | 30 | A | AAA |
| 29 | Comp. ex. | AAA | 1 | 2.6 | 2 | A | B |
| 30 | Comp. ex. | AAA | 2 | 2.6 | 1 | A | B |
| 31 | Comp. ex. | AAA | 5 | 2.4 | 20 | A | B |
| 32 | Comp. ¥ ex. | AAA | 1 | 2.5 | 2 | A | B |
| 33 | Comp. ex. | AAA | 1 | 2.6 | 1 | A | B |
| 34 | Comp. ex. | AAA | 7 | 2.5 | 21 | A | B |
| 35 | Comp. ex. | AAA | 5 | 2.6 | 2 | A | B |
| 36 | Comp. ex. | Not evaluable due to | | | | | |
| 37 | Comp. ex. | nonplating defect | | | | | |
| 38 | Comp. ex. | AAA | 2 | 2.4 | 1 | A | B |
| 39 | Comp. ex. | AAA | 9 | 2.4 | 8 | A | B |
| 40 | Comp. ex. | AAA | 1 | 2.5 | 1 | A | B |
| 41 | Comp. ex. | AAA | 8 | 2.7 | 5 | A | B |
| 42 | Comp. ex. | AAA | 11 | 3.2 | 7 | A | B |

*Underlines show outside scope of present invention or desired properties not obtained.

No. 29 is a comparative example with a large content of C in the base steel sheet of the plated steel sheet. Since the content of C of the base steel sheet was large, it is believed that even with high dew point annealing, no progress was made in decarburization at the surface layer. For this reason, the depth with a C concentration at the non-heat affected zone of 0.05% or less became smaller and the thickness with an area ratio of the ferrite phase at a position 500 μm to the outside from the end of the pressure contact zone of 90% or more became smaller. As a result, the LME resistance at the time of production of the welded joint became inferior.

No. 30 is a comparative example with a small content of Si in the base steel sheet of the plated steel sheet and a small sum of the contents of Si and sol. Al. Since the content of Si of the base steel sheet was small, it is believed that even with high dew point annealing, no progress was made in decarburization at the surface layer and the ferrite was not stabilized. For this reason, the depth with a C concentration at the non-heat affected zone of 0.05% or less became smaller and the thickness with an area ratio of the ferrite phase at a position 500 μm to the outside from the end of the pressure contact zone of 90% or more became smaller. As a result, the LME resistance at the time of production of the welded joint became inferior.

No. 31 is a comparative example with a large content of Si in the base steel sheet of the plated steel sheet. Since the content of Si of the base steel sheet was large, it is believed that even with high dew point annealing, external oxidation proceeded, oxide (scale) was formed on the surface layer of the steel sheet, and decarburization at the surface was suppressed. For this reason, the depth with a C concentration at the non-heat affected zone of 0.05% or less became smaller. As a result, the LME resistance at the time of production of the welded joint became inferior.

No. 32 is a comparative example with a small content of sol. Al in the base steel sheet of the plated steel sheet. Since the content of sol. Al of the base steel sheet was small, it is believed that even with high dew point annealing, no progress was made in decarburization at the surface layer and the ferrite was not stabilized. For this reason, the depth with a C concentration at the non-heat affected zone of 0.05% or less became smaller and the thickness with an area ratio of the ferrite phase at a position 500 μm to the outside from the end of the pressure contact zone of 90% or more became smaller. As a result, the LME resistance at the time of production of the welded joint became inferior.

No. 33 is a comparative example with a small content of sol. Al in the base steel sheet of the plated steel sheet and a small sum of the contents of Si and sol. Al. Since the content of sol. Al of the base steel sheet was small and the sum of the contents of Si and sol. Al was small, it is believed that even with high dew point annealing, no progress was made in decarburization at the surface layer and the ferrite was not stabilized. For this reason, the depth with a C concentration at the non-heat affected zone of 0.05% or less became smaller and the thickness with an area ratio of the ferrite phase at a position 500 μm to the outside from the end of the pressure contact zone of 90% or more became smaller. As a result, the LME resistance at the time of production of the welded joint became inferior.

No. 34 is a comparative example with a large content of sol. Al in the base steel sheet of the plated steel sheet. Since the content of sol. Al of the base steel sheet was large, it is believed that even with high dew point annealing, external oxidation proceeded, oxide (scale) was formed on the surface layer of the steel sheet, and decarburization at the surface was suppressed. For this reason, the depth with a C concentration at the non-heat affected zone of 0.05% or less became smaller. As a result, the LME resistance at the time of production of the welded joint became inferior.

No. 35 is a comparative example with a small total of contents of Si and Al of the base steel sheet of the plated steel sheet. Since the total of contents of Si and sol. Al of the base steel sheet was small, it is believed that even with high dew point annealing, no progress was made in decarburization at the surface layer and the ferrite did not become stable. For this reason, the depth with a C concentration at the non-heat affected zone of 0.05% or less became smaller and the thickness with an area ratio of the ferrite phase at a position 500 μm to the outside from the end of the pressure contact zone of 90% or more became smaller. As a result, the LME resistance at the time of production of the welded joint became inferior.

No. 36 was low in dew point at the time of annealing at the time of production of the plated steel sheet, so it is believed a layer including oxides of Si, Mn, Al, etc. was formed at the outside of the steel sheet at the time of annealing and, at the time of plating, mutual dispersion of the plating constituents and steel constituents was obstructed. As a result, suitable plating was not performed, so the welded joint was not evaluated.

No. 37 was high in dew point at the time of annealing at the time of production of the plated steel sheet, so it is believed a layer including oxides of Si, Mn, Al, etc. was formed at the outside of the steel sheet at the time of annealing and, at the time of plating, mutual dispersion of the plating constituents and steel constituents was obstructed. As a result, suitable plating was not performed, so the welded joint was not evaluated.

No. 38 was low in holding temperature at the time of annealing at the time of production of the plated steel sheet, so it is believed decarburization was not sufficiently promoted at the time of annealing. For this reason, the depth with a C concentration at the non-heat affected zone of 0.05% or less became smaller and the thickness with an area ratio of the ferrite phase at a position 500 μm to the outside from the end of the pressure contact zone of 90% or more became smaller. As a result, the LME resistance at the time of production of the welded joint became inferior.

No. 39 is a comparative example with a high annealing temperature at the time of production of the plated steel sheet. Since the holding temperature at the time of annealing was high, it is believed that decarburization was not sufficiently promoted at the time of annealing. For this reason, the depth with a C concentration at the non-heat affected zone of 0.05% or less became smaller and the thickness with an area ratio of the ferrite phase at a position 500 μm to the outside from the end of the pressure contact zone of 90% or more became smaller. As a result, the LME resistance at the time of production of the welded joint became inferior.

No. 40 is a comparative example with a short annealing time at the time of production of the plated steel sheet. Since the holding time at the time of annealing was short, it is believed that decarburization was not sufficiently promoted at the time of annealing. For this reason, the depth with a C concentration at the non-heat affected zone of 0.05% or less became smaller and the thickness of the layer with an area ratio of ferrite phase of 90% or more at a position of 500 μm at the outside from an end part of the pressure contact zone became smaller. As a result, the LME resistance at the time of production of the welded joint became inferior.

In No. 41, no brush grinding was performed at the pretreatment step at the time of plated steel sheet production, so it is believed no strain was introduced to the surface of the steel sheet and decarburization did not proceed at the time of annealing. For this reason, the depth with a C concentration at the non-heat affected zone of 0.05% or less became smaller and the thickness of the layer with an area ratio of ferrite phase of 90% or more at a position of 500 μm at the outside from an end part of the pressure contact zone became smaller. As a result, the LME resistance at the time of production of the welded joint became inferior.

In No. 42, a brush roll with a large grinding amount was used in the pretreatment step at the time of production of the plated steel sheet, so it is believed that the surface of the base steel sheet became greater in roughness and the ferrite phase did not become stable. For this reason, the thickness of the layer with an area ratio of ferrite phase of 90% or more at a position of 500 μm at the outside from an end part of the pressure contact zone became smaller. As a result, the LME resistance at the time of production of the welded joint became inferior.

Nos. 1 to 28 are examples of the present invention. The LME at the time of production of the welded joint was suppressed. In examples where the depth with a C concentration at the non-heat affected zone of 0.05% or less was large and the thickness of the layer with an area ratio of ferrite phase of 90% or more at a position of 500 μm at the outside from an end part of the pressure contact zone was large, it was confirmed that particularly excellent LME resistance was possessed.

### INDUSTRIAL APPLICABILITY

According to the present invention, it becomes possible to provide a welded joint suppressed in LME cracking at the time of production. The welded joint can be suitably used for automobiles, household electric appliances, building materials, and other applications, in particular for automobiles. Therefore, the present invention is an invention with extremely high industrial applicability.

### REFERENCE SIGNS LIST

1. steel sheet
2. nugget
3. pressure contact zone
4. separation zone
5. heat affected zone
6. overlaid surface
11. crack right outside pressure contact zone

1. A welded joint comprising
a plurality of overlaid steel sheets,
a spot welded part having a nugget joining the plurality of steel sheets and a pressure contact zone and heat affected zone formed in the surroundings of the nugget, and
a separation zone formed around the pressure contact zone,
wherein
at least one of the steel sheets among the plurality of steel sheets is a plated steel sheet provided with a base steel sheet and a plating layer, the plating layer formed on at least a surface corresponding to an overlaid surface of the plurality of steel sheets and containing Zn;
a tensile strength of the plated steel sheet is 780 MPa or more;
the chemical composition of the base steel sheet comprises by mass %,
C: 0.05 to 0.40%,
Si: 0.7 to 3.0%,
Mn: 0.1 to 5.0%,
sol. Al: 0.7 to 2.0%,
P: 0.0300% or less,
S: 0.0300% or less,
N: 0.0100% or less,
B: 0 to 0.010%,
Ti: 0 to 0.150%,
Nb: 0 to 0.150%,
V: 0 to 0.150%,
Cr: 0 to 2.00%,
Ni: 0 to 2.00%,
Cu: 0 to 2.00%,
Mo: 0 to 1.00%,
W: 0 to 1.00%,
Ca: 0 to 0.100%,
Mg: 0 to 0.100%,
Zr: 0 to 0.100%,
Hf: 0 to 0.100%,
REM: 0 to 0.100% and
a balance of Fe and impurities,
a total value of contents of Si and sol. Al is 1.8% or more;
at a non-heat affected zone of the welded joint,
a depth with a C concentration measured by GDS of 0.05% or less in a depth direction of the base steel sheet starting from an interface of the plating layer and the base steel sheet of the plated steel sheet is 10 μm or more,
a roughness of the interface of the plating layer and the base steel sheet of the plated steel sheet is an Ra of 3.0 μm or less; and
at a position of 500 μm to the outside from an end part of the pressure contact zone, a thickness of a layer with an area ratio of a ferrite phase of 90% or more in a depth direction of the base steel sheet starting from an interface of the plating layer and the base steel sheet of the plated steel sheet is 15 μm or more.

2. The welded joint according to claim 1, wherein the depth with a C concentration measured by GDS of 0.05% or less in a depth direction of the base steel sheet starting from an interface of the plating layer and the base steel sheet of the plated steel sheet at the non-heat affected zone of the welded joint is 15 μm or more.

3. The welded joint according to claim 1, wherein the thickness of the layer with an area ratio of a ferrite phase of 90% or more in the depth direction from the base steel sheet starting from an interface of the plating layer and the base steel sheet of the plated steel sheet at a position of 500 μm to the outside from an end part of the pressure contact zone is 30 μm or more.

4. The welded joint according to claim 1, wherein the depth with a C concentration measured by GDS of 0.05% or less in a depth direction of the base steel sheet starting from an interface of the plating layer and the base steel sheet of the plated steel sheet at the non-heat affected zone of the welded joint is 15 μm or more and the thickness of the layer with an area ratio of a ferrite phase of 90% or more in the depth direction from the base steel sheet starting from an interface of the plating layer and the base steel sheet of the plated steel sheet at a position of 500 μm to the outside from an end part of the pressure contact zone is 30 μm or more.

5. The welded joint of claim 1, wherein a roughness of the interface of the plating layer and the base steel sheet of the plated steel sheet at the non-heat affected zone is an Ra of 2.0 μm or less.

6. The welded joint of claim 2, wherein a roughness of the interface of the plating layer and the base steel sheet of the plated steel sheet at the non-heat affected zone is an Ra of 2.0 μm or less.

7. The welded joint of claim 3, wherein a roughness of the interface of the plating layer and the base steel sheet of the plated steel sheet at the non-heat affected zone is an Ra of 2.0 μm or less.

8. The welded joint of claim 4, wherein a roughness of the interface of the plating layer and the base steel sheet of the plated steel sheet at the non-heat affected zone is an Ra of 2.0 μm or less.
